(19) United States
(12) Patent Application Publication
(10) Pub. No.: US 2010/0060547 A1
(43) Pub. Date: Mar. 11, 2010

(54) Display Device and Method for Displaying Images in a Variable Size Display Area

(75) Inventors: Leland Scott Bloebaum, Cary, NC (US); Ivan Nelson Wakefield, Cary, NC (US)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 12/208,605

(22) Filed: Sep. 11, 2008

(51) Int. Cl. G09G 5/00

(52) U.S. Cl. 345/1.3

(57) ABSTRACT

An image is displayed on a variable display area defined by two or more relatively moveable displays. A detector detects movement of the displays that varies the size of the display area. A processor determines the size of the new display area created by the relative movement of the displays and dynamically alters the displayed image to fit the new display area responsive to the detection of movement.

### BACKGROUND

In recent years, mobile phones have evolved from devices used primarily for voice communications into multi-functional communication devices capable of both voice and data communications. Mobile telephones are now used to surf the web, send and receive e-mail messages, chat with friends, view images, play music, and perform other tasks that previously required a computer. Many mobile telephones now also include a camera for capturing still and video images.

One of the challenges facing manufacturers of mobile telephones is how to increase the display area without significantly increasing the size of the mobile telephone. A larger display area makes it easier to use the mobile telephone and is generally preferred by consumers. At the same time, consumers prefer mobile telephones that have a small form factor. Therefore, there is a need for new ways to increase the display area while, at the same time, maintaining a small form factor.

### SUMMARY

The present invention provides an enabling technology for increasing the size of a display area on a mobile telephone or other hand-held device while maintaining a small form factor. A mobile telephone or other device may be provided with two or more displays that slide relative to one another to vary the size of the available display area. For example, the displays may be arranged in an overlapping relation and configured for relative sliding movement. A detector detects relative movement of the displays. In response to the relative movement, a processor determines the size of the available display area and dynamically alters the displayed image to fit the available display area. Thus, a displayed image may be enlarged as the display area increases in size, and may be reduced as the display area decreases in size.

Exemplary embodiments of the invention comprise a method of controlling the display of an image on a variable display area defined by at least two relatively movable displays. The method comprises displaying an image to fit a first display area; detecting relative movement between said displays varying the size of the display area while the image is displayed; determining the size of a second display area created by the relative movement of the displays; dynamically altering the displayed image to fit the second display area responsive to the detection of the relative movement; and outputting the altered image for display on at least one of said displays.

In one exemplary method, the displays overlap and the relative movement exposes or conceals a portion of one of said displays to vary the display area.

In one exemplary method, the relative movement comprises sliding movement in at least one direction.

In one exemplary method, dynamically altering the displayed image comprises at least one of cropping/uncropping the image, scaling the image, and stretching/shrinking the displayed image in one dimension.

The exemplary method may further comprise shifting the image in the second display area to center the altered image in the second display area.

In one exemplary method, detecting the relative movement between said displays comprises detecting the relative movement using at least one motion detector.

In one exemplary method, the motion detector comprises an accelerometer for detecting relative movement between said displays.

In one exemplary method, the motion detector comprises a separate accelerometer for detecting movement of each display.

In one exemplary method, detecting the relative movement between said displays comprises detecting a change in position using at least one position detector.

In one exemplary method, the position detector comprises one or more optical sensors.

Exemplary embodiments of the present invention also include a display device comprising first and second displays relative movable with respect to one another to vary a display area visible to a user; a detector to detect relative movement between the displays varying the size of the display area; a processor configured to determine the size of the available display area and to alter an image to fit the size of the available display area responsive to the detection of the relative movement between said displays by said detector; and a display controller to output the altered image for display on at least one of said first and second displays.

In one exemplary display device, the first and second displays overlap.

In one exemplary display device, the first and second displays slide relative to one another.

In one exemplary display device, the processor alters the image to fit the available display area by performing at least one of cropping/uncropping the image, scaling the image, or stretching/shrinking the displayed image in one dimension.

In one exemplary display device, the processor further shifts the displayed image to maintain the image centered in the display.

In one exemplary display device, the detector comprise at least one motion detector.

In one exemplary display device, the motion detector comprises an accelerometer for detecting relative movement between the displays.

In one exemplary display device, the motion detector comprises a separate accelerometer for detecting movement of each display.

In one exemplary display device, the detector comprises a position detector.

In one exemplary display device, the position detector comprises one or more optical sensors.

### BRIEF DESCRIPTION OF THE DRAWINGS

FIG. 1 illustrates and exemplary mobile communication device having a variable size display area.

FIG. 2 illustrates a display system for the mobile communication device for displaying an image in a variable size display area

FIGS. 3A-3C illustrate cropping and image to fit a variable size display area.

FIGS. 4A-4C illustrate scaling an image to fit a variable size display area.

FIGS. 5A-5C illustrate stretching and image to fit a variable size display area.

FIG. 6 illustrates an exemplary method for displaying images on a variable size display area.

### DETAILED DESCRIPTION

Referring now to the drawings, a mobile communication device according to one exemplary embodiment of the present invention is shown therein and indicated generally by the numeral 100. The illustrated embodiment of the mobile communication device comprises a smart phone or personal digital assistant (PDA). Those skilled in the art will appreciate that the mobile communication device 100 may also comprise a tablet, laptop computer, or notebook with wireless communications capabilities.

Mobile communication device 100 comprises a housing 102 having first and second housing sections 104, 106. The first housing section 104, referred to herein as the top section, includes an electronic display 120 and a control button 122. The electronic display 120 preferably comprises a touchscreen display, but may comprise a conventional liquid crystal display or other types of electronic displays. The second housing section 106, referred to herein as the bottom section, also includes an electronic display 124, which may also comprise a touchscreen display or liquid crystal display.

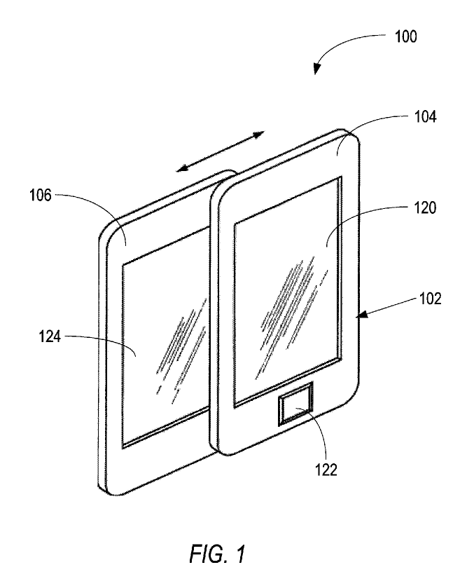

The top and bottom sections 104,106 of housing 102 slide relative to one another as indicated by the arrow in FIG. 1. In one embodiment, the bottom section 106 may slide to a position behind the top housing section 104 in which the second display 124 is concealed from the user's view (the hidden position). The bottom housing section 106 may slide out from behind the top housing section 104 so that display 124 is viewable by the user. The bottom section 102 may slide to a position in which display 124 is fully uncovered (the full view position), or to a position in which display 124 is partially covered by the top section 104 (a partial view position).

According to the present invention, mobile communication device 100 may operate in a single display mode or multi-display mode. In the single display mode, second display 124 is hidden from view and the mobile communication device 100 outputs images to the first display 120. In the multi-display mode, the second display 124 is at least partially exposed to view. Also in the multi-display mode, the mobile communication device 100 treats displays 120, 124 as a single display when displaying images or video. The total available display area is therefore the combined visible area of displays 120, 124. While an image is displayed, the user may slide or move the displays 120, 124 to change the size of the available display area. In response to movement of the displays 120, 124, mobile communication device 100 dynamically alters the displayed image in real time to give the user the impression that the user is physically manipulating the image. For example, the image may become larger as the user increase the size of the display area, and may become smaller as the user decrease the size of the display area.

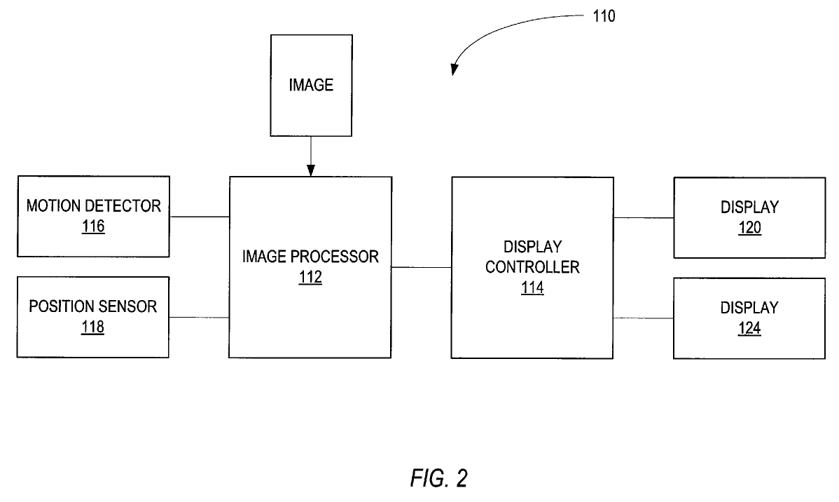

FIG. 2 shows an exemplary display system 110 for a mobile communication device 100. The display system 110 comprises an image processor 112, display controller 114, motion detector 116, and displays 120 and 124. Motion detector 116 detects relative movement between displays 120, 124 and generates a signal that is input to the image processor 112. The motion detector 116 may comprise, for example, one or more accelerometers. A single accelerometer can be configured to detect relative movement between the displays 120, 124. Also, movement of each display 120, 124 may be separately detected by two accelerometers; one for each display 120, 124. The image processor 112 could then determine the relative movement between the displays 120, 124 based on the movement of each individual display 120, 124. Alternatively, one or more position sensors 118, such as optical sensors, may be used to detect movement of the displays 120, 124. In this case, movement is indicated by a change in absolute or relative positions of the displays 120, 124. The available display area will vary in size as the user moves the displays 120, 124 relative to one another. In response to movement of the displays 120, 124, image processor 112 determines the size of the available display area based on the positions of displays 120, 124. The image processor 112 processes the input image to fit the available display area. As described in greater detail below, the image processor 112 may crop, scale, and/or stretch the input image to fit the available display area.

Image processor 112 outputs the resized image to the display controller 114. In the exemplary embodiment, display controller 114 includes two video outputs, one for each display 120, 124. The display controller 114 maps the image data to displays 120, 124 depending on the position of the displays 120, 124. If display 124 is hidden from view, the display controller 114 maps the entire image to the first display 120 and generates a video signal for the display 120. If the display area includes a portion of display 124, the display controller 114 treats the entire available display area as a single display, maps the image data to displays 120, 124, and generates a video output signal for both displays 120, 124.

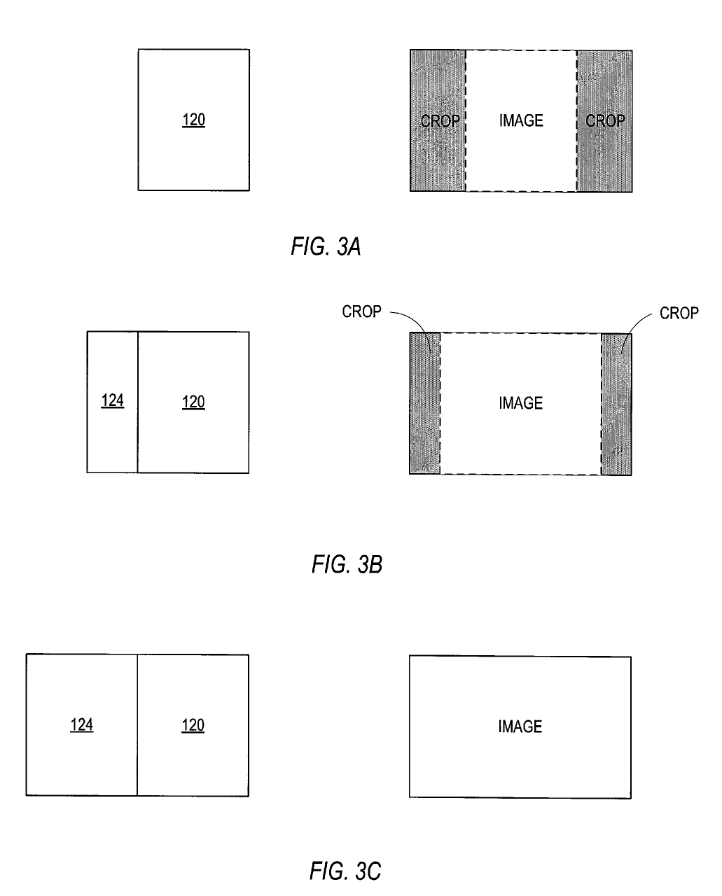

FIGS. 3A-3C illustrate a first exemplary method for processing an image to fit a variable display area. In FIGS. 3A-3C, the configuration of the displays 120, 124 is illustrated schematically on the left side, and the input image is illustrated on the right-hand side. The input image and the displays 120, 124 may have different aspect ratios, e.g., 6:4 and 4:3, respectively. In this example, the image processor 112 implements a cropping algorithm to continually resize the image as display 124 slides in or out from behind the display 120. As the display 124 slides out, more of the image is displayed. Conversely, as the display 124 slides behind the display 120, less of the image is displayed. The resizing of the image using a cropping algorithm is done continuously responsive to movement of the displays 120, 124 to give the user the impression that the user is physically expanding and reducing the image.

In FIG. 3A, display 124 is hidden from view. The image processor 102 in this case crops the shaded portion of the input image to fit display 120. In this example, both sides of the image are cropped as needed to fit the image to the display area. Alternatively, one side of the image may be justified with an edge of the display area and the opposite side cropped as needed to fit the display area. Also, both sides of the image may be justified with opposing edges of the display area and a center portion of the image cropped as needed to fit the display area. When the image is cropped, the user may use an input control, such as a navigation key, to pan the image. When the image is panned by the user, the image processor 112 determines a new center point of the image and crops the input image relative to the new center point to fit the display area.

When the user slides display 124 out from behind display 120, the size of the display area increase. In FIG. 3B, approximately one-half of display 124 is visible. In this case, the image processor 112 determines the size of the available display area considering both displays 120 and 124 and resizes the image to fit the recalculated display area. The input image is then cropped to fit the available display area of displays 120 and 124. In FIG. 3C, display 124 is fully extended so that display 124 is fully visible. In this case, the input image fits the available display area so no cropping is required to fit the image to the display area.

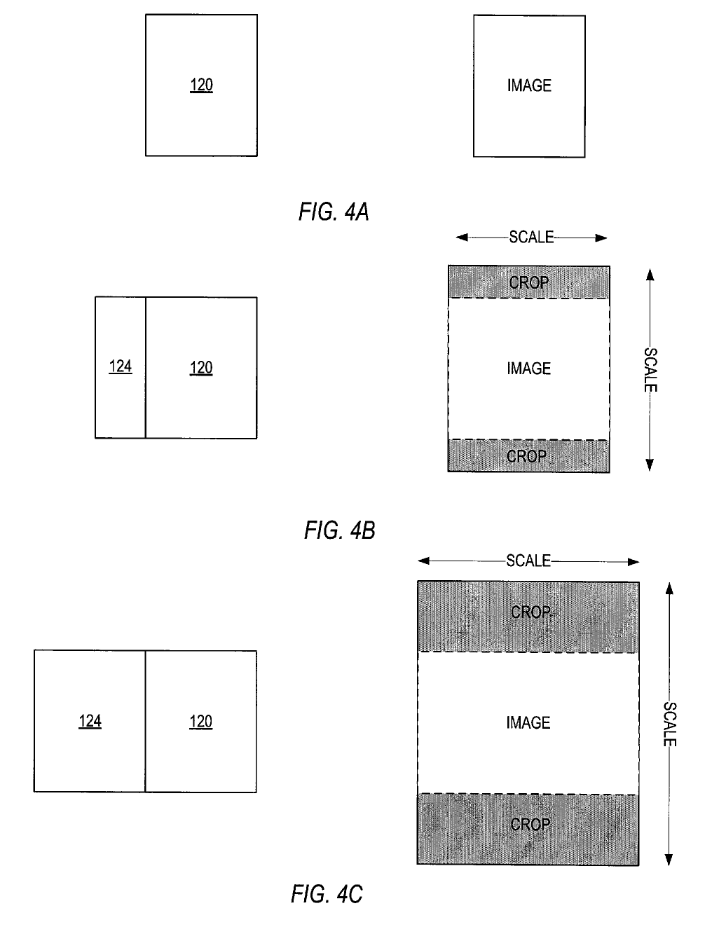

FIGS. 4A-4C illustrate another exemplary method for processing an image to fit a variable display area. In this embodiment, image processor 112 enlarges (zooms in) or reduces (zooms out) the input image responsive to the movement of the displays 120, 124. In FIGS. 4A-4C, the configuration of displays 120, 124 is shown schematically on the left side, and the input image is shown on the right side. In this example, the aspect ratio of the displays 120, 124 and the input image may be the same, e.g., 4:3. Image processor 112 implements a scaling algorithm to resize the image as the user moves the displays 120, 124. The image processor 112 increases the size of the input image as the user slides display 124 out from behind display 120, and decreases the size of the input image as the user slides display 124 behind display 120. Thus, the relative movement of the displays 120, 124 provides a convenient method for zooming in and zooming out on an image. Using the relative movement between displays 120, 124 to control the size of the image gives the user the impression that he or she is physically expanding and reducing the image by moving the displays 120, 124.

In FIG. 4A, display 124 is hidden from view and the input image is scaled to fit display 120. Because the aspect ratio of the input image is the same as the aspect ratio of display 120, the full image is viewable in display 120. If the aspect ratios do not match, the image may be scaled to fit either the height or width of the display 120 and cropped. FIG. 4B and 4C show display 124 in the partial view and full view positions respectively. As the display area increase, the input image is scaled to fit the width of the display area and a portion of the image along the top and bottom is cropped. Those skilled in the art will appreciate, however, that the image may alternatively or additionally be scaled to fit the height of the display area in other embodiments.

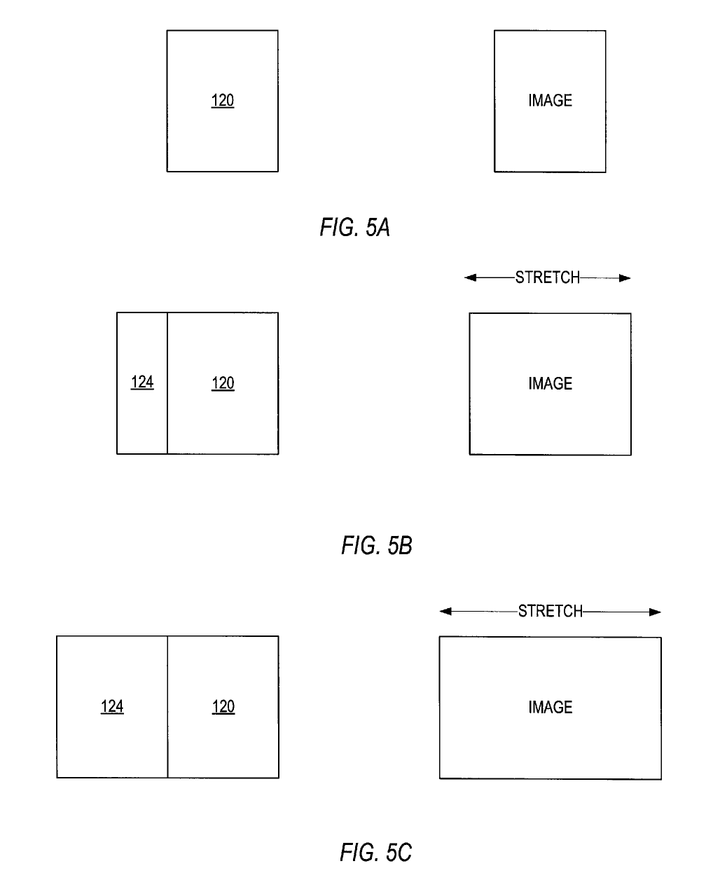

FIGS. 5A-5C illustrate a third method of processing an image for display in a variable display area. In this embodiment, the movement of the displays 120, 124 provides a control for stretching/unstretching an image. In the example shown in FIGS. 5A-5C, the original image and the displays 120, 124 may have the same aspect ratio, e.g., 4:3. When display 124 is hidden from view as shown in FIG. 5A, the image is displayed on display 120. Because the aspect ratio of the image matches the aspect ratio of the display 120, the full image is displayed. If there was a mismatch in the aspect ratios of the display 120 and the input image, the image may be cropped to fit the display area of the display 120.

FIGS. 5B and 5C illustrate the display 124 in the partial view position and full view position, respectively. As display 124 slides out from behind display 120, the original image is stretched in the horizontal direction to fill the combined display area of displays 120, 124. The image processor 112 may implement a morphing algorithm to stretch the image in the horizontal dimension to produce a humorous effect. Alternatively, the image processor 112 may implement a content-aware image-resizing algorithm, also known as a seam carving algorithm. Seam carving algorithms operate on “seams” which comprise a sequence of adjacent pixels that run from one side of the image to the other along a row or column. Removing all pixels in a seam reduces the height or width of an image by one pixel. Conversely, adding a row or column of pixels increases the height or width of the image. Repeated insertion or deletion of seams may achieve any amount of stretching or shrinking.

Seam carving algorithms typically scan the image and find seams with the least amount of “interestingness.” For example, when shrinking the image along one dimension, the seam carving algorithm looks for a pixel-wide path with the least amount of change in color and/or contrast along the path. Removing that seam reduces the dimension of the image by one pixel width. The same approach may be used to make the image wider by duplicating a seam.

When the user slides display 124 out from behind display 120, a morphing or seam carving algorithm may be used to stretch the image in the horizontal direction. Conversely, when display 124 slides behind display 120 to reduce the display area, the image may be shrunk in the horizontal direction. Thus, the user is given the impression that the user is stretching and shrinking the image by moving the displays 120, 124 relative to one another.

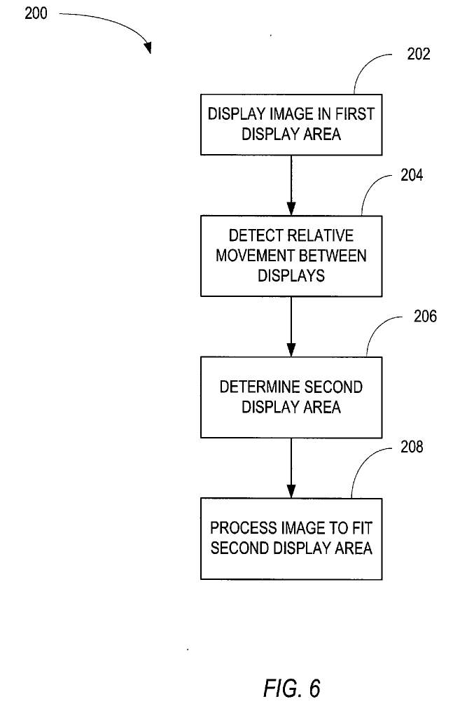

FIG. 6 illustrates a method 200 implemented by mobile communication device 100. The mobile communication device 100 displays an image to fit a first display area (block 202). The first display area may include parts of a single display 120, 124 or parts of multiple displays 120, 124. Those skilled in the art will appreciate that the mobile communication device 100 may need to crop, scale, stretch, or shrink the image to fit the first display area. When the user moves the displays 120, 124 relative to one another so that the size of the available display area changes. The mobile communication device 100 detects the movement (block 204), determines the size of the available display area (block 206), and dynamically alters the displayed image to fit a second display area (block 208). As noted above, fitting the image to the new display area may involve cropping, scaling, stretching, or shrinking the image. Whatever algorithms are used, the image-fitting process is performed in a continuous manner while the displays 120, 124 are moved to give the user the impression that the user is physically enlarging or reducing the image by moving the displays 120, 124.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of controlling the display of an image on a variable display area defined by at least two relatively movable displays, said method comprising:
displaying an image to fit a first display area;
detecting relative movement between said displays varying the size of the display area while the image is displayed;
determining the size of a second display area created by the relative movement of the displays;
dynamically altering the displayed image to fit the second display area responsive to the detection of the relative movement; and
outputting the altered image for display on at least one of said displays.

2. The method of claim 1 wherein said displays overlap and wherein said relative movement exposes or conceals a portion of one of said displays to vary the display area.

3. The method of claim 2 wherein said relative movement comprises sliding movement in at least one direction.

4. The method of claim 1 wherein dynamically altering the displayed image comprises at least one of cropping/uncropping the image, scaling the image, and stretching/shrinking the displayed image in one dimension.

5. The method of claim 4 further comprising shifting the image in the second display area to center the altered image in the second display area.

6. The method of claim 1 wherein detecting the relative movement between said displays comprises detecting the relative movement using at least one motion detector.

7. The method of claim 6 wherein the motion detector comprises an accelerometer for detecting relative movement between said displays.

8. The method of claim 6 wherein the motion detector comprises a separate accelerometer for detecting movement of each display.

9. The method of claim 1 wherein detecting the relative movement between said displays comprises detecting a change in position using at least one position detector.

10. The method of claim 9 wherein said position detector comprises one or more optical sensors.

11. A display device comprising:
first and second displays relative movable with respect to one another to vary a display area visible to a user;
a detector to detect relative movement between the displays varying the size of the display area;
a processor configured to determine the size of the available display area and to alter an image to fit the size of the available display area responsive to the detection of the relative movement between said displays by said detector; and
a display controller to output the altered image for display on at least one of said first and second displays.

12. The display device of claim 11 wherein said first and second displays overlap.

13. The display device of claim 12 wherein said first and second displays slide relative to one another.

14. The display device of claim 11 wherein the processor alters the image to fit the available display area by performing at least one of cropping/uncropping the image, scaling the image, or stretching/shrinking the displayed image in one dimension.

15. The display device of claim 14 wherein the processor further shifts the displayed image to maintain the image centered in the display.

16. The display device of claim 11 wherein the detector comprise at least one motion detector.

17. The display device of claim 16 wherein the motion detector comprises an accelerometer for detecting relative movement between the displays.

18. The display device of claim 16 wherein the motion detector comprises a separate accelerometer for detecting movement of each display.

19. The display device of claim 11 wherein the detector comprises a position detector.

20. The display device of claim 19 wherein the position detector comprises one or more optical sensors.
